(19) United States
(12) Patent Application Publication
(10) Pub. No.: US 2002/0017986 A1
(43) Pub. Date: Feb. 14, 2002

(54) Brake failure detection method and apparatus

(76) Inventors: Gary C. Causley, Aloha, OR (US); Wayne L. Mann, Tualatin, OR (US); Douglas Mark, Aloha, OR (US)

Correspondence Address: DELLETT AND WALTERS, 310 S.W. FOURTH AVENUE, SUITE 1101, PORTLAND, OR, 97204, US

(21) Appl. No.: 09/778,308

(22) Filed: Feb. 6, 2001

Related U.S. Application Data
(60) Provisional application No. 60/180,920, filed on Feb. 8, 2000.

(51) Int. Cl. G06F 7/70; B60Q 1/00

(52) U.S. Cl. 340/453; 701/70; 701/80

(57) ABSTRACT

A contact free vehicle brake failure sensor receives IR emissions from a brake region of a vehicle to determine the temperature of the brake region. A determination of non-functionality of a brake is made based on whether the brake region is near the ambient temperature.

### BACKGROUND OF THE INVENTION

This invention relates to trucking and automotive applications, and more particularly to a contact free brake failure detection method and apparatus for quickly determining whether there is a likelihood that a vehicle's brakes are non-functional.

In the transportation industry, especially in the trucking industry, inspection of vehicles is routinely done, to ensure that components are functioning correctly. Such inspections are made to assure safety, for example. Often, such inspections are made by governmental agencies, either on a regular basis at specific locations, such as roadside weigh stations or inspection stations, or on a surprise basis when a vehicle is stopped, by a state police officer or the like.

A prime safety component requiring inspection is a vehicle's brakes, since failure of brakes is a major safety hazard. However, inspecting brakes for functionality requires that an inspector crawl under a vehicle, or reach around behind the vehicle's wheels. Such inspections are time consuming and unpleasant for the inspector.

In the railroad industry, it has been known to use IR sensors to detect hot wheel bearings and brakes, looking for stuck brakes or overheating bearings. Such applications, while useful in rail applications, have not proved helpful in trucking and automotive applications. One reason for such inapplicability is that the operational mode of rail is different than trucking or automotive uses. The rail cars are essentially unattended and far removed from the engineer, and large number of cars are connected together, so a stuck brake on one car does not provide a noticeable change in the speed or function of the overall train. In contrast, in trucking, stuck brakes are immediately apparent to a driver. Non-functional brakes, however, may be difficult to detect, especially in the case of a vehicle operator who wishes to hide the poor mechanical condition of the vehicle's brakes from an inspector.

### SUMMARY OF THE INVENTION

In accordance with the invention, a contact free sensor system and method are provided, wherein sensors are located beneath a path of travel of a vehicle. The sensors look up towards the brake assemblies of the vehicle as it passes overhead. Detection of a brake assembly that is at or near ambient temperature indicates a non-functional condition.

Accordingly, it is an object of the present invention to provide an improved brake functionality detector and method.

It is a further object of the present invention to provide an improved method for determining whether the brakes of a vehicle are functioning.

It is yet another object of the present invention to provide an improved method and apparatus for inspectors to employ in the inspection of brakes of trucks.

A further object of the present invention is to provide an improved inspection system that enables contact free detection of potentially non-functional brakes.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a system according to the present invention;

FIG. 2 is a schematic diagram of a system according to the invention installed for automated inspection of truck brakes;

FIG. 3 is a flow chart of decision steps made in operation of the system according to the invention; and

FIG. 4 is a partial cross sectional view of an IR sensor employed in a particular embodiment of the invention.

### DETAILED DESCRIPTION

The system according to a preferred embodiment of the present invention comprises two infrared (IR) sensors, which are positioned to be beneath a vehicle. Each sensor is aimed to receive the IR emissions from wheels on opposing sides of the vehicle as the vehicle is driven over a sensor station in which the sensors are mounted. Detection of brakes that are at or near ambient temperature provides an indication of possible brake failure.

The IR sensors employed in accordance with the invention suitably comprise sensors as disclosed in U.S. Pat. No. 5,796,344, entitled IMMINENT ICING CONDITION ENUNCIATOR, the disclosure of said patent being incorporated herein by reference.

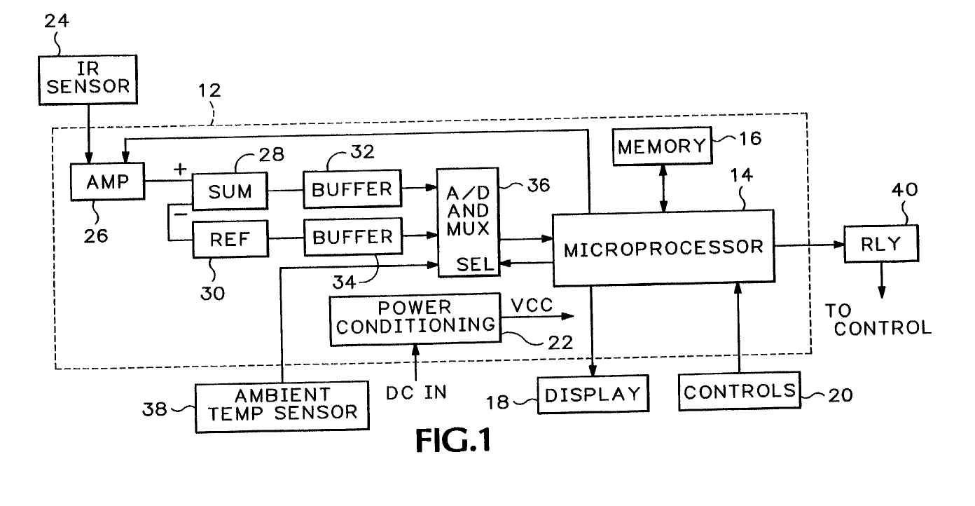

Referring to FIG. 1, a block diagram of a system according to the present invention a processing circuitry block 12 comprises a microprocessor 14, which includes memory 16 for storing the operational instructions and data therefor. Memory 16 may comprise a RAM/ROM combination, EEROM, or the like. The microprocessor interfaces with display 18 which may comprise, for example, a pass/fail display, a specific temperature read-out, or any suitable indicator. The display may also include a digital readout of air and road surface temperatures or other suitable message. Operator commands are supplied to the processor via controls 20, which may include on/off switch or the like. Power for the various components is supplied by power conditioning block 22, which takes a DC voltage input (DCᵢₙ) from, for example, a battery. Data from dual IR sensors 24 is fed through a variable amplifier 26 (which receives amplification level control information from the microprocessor) to a plus (+) side of a summing circuit 28, while the minus (−) side of summing circuit 28 is connected to reference block 30 (REF). The output from summing circuit 28 and reference block 30 are supplied, via buffers 32 and 34 to analog-to-digital converter/multiplexer block 36 (A/D & MUX). Output from an ambient temperature sensor 38 is also received by A/D & MUX 36. The microprocessor receives input data from A/D & MUX 36, as selected by microprocessor control of the select lines (SEL) of the multiplexer. Microprocessor 14 also provides an additional output to a control circuit 40 which may comprise a relay, for example, and the output thereof is supplied to any other equipment that is desired to be controlled by or operate in response to the sensor system.

In operation, sensors 24 generate a voltage output based on the amount of infrared radiation detected and, as altered by amplifier 26, summing block 28 and buffer 32, is converted to digital values by A-to-D converter 36. Similarly, the ambient air temperature sensor 38 voltage output, which is representative of air temperature, is also supplied to A-to-D converter 36 for conversion-to-digital values. Block 36 supplies a multiplexed output so as to provide the digitized infrared sensed data from block 24 and the digitized ambient air sensed data from block 38 in alternate fashion to microprocessor 14. The reference block 30 in conjunction with summing block 28 enables a precision measurement of the output of sensors 24.

Amplifier 26 is controlled by microprocessor 14 to vary the level of amplification of the signal coming from infrared sensors 24.

In operation, the stored program and data in memory 16 includes operational software for the microprocessor so as to periodically sample the data from multiplexer 36 and to provide an indication of the temperature of brake components of a vehicle based on the input infrared sensor data and ambient air sensor data. This may be accomplished, for example, via use of look-up tables, which hold empirically determined values correlating the sensed voltage values from infrared sensors 24 and air temperature sensor 38 with actual brake component surface temperatures. If the sensed temperature is within a range of the ambient temperature, then an indication is provided to display 18 that the specific brake component is apparently nonfunctional. Since when driving into an inspection station, the vehicle operator will have applied to brakes in order to slow down to the inspection point, all functioning brakes will be warmed up as a result of the friction of the brake components. Any brake components that have remained at or near the ambient temperature are likely to be not functioning, since they have not heated up. Therefore, a quick determination is made that further investigation is necessary to see whether the brakes are functioning on a particular vehicle.

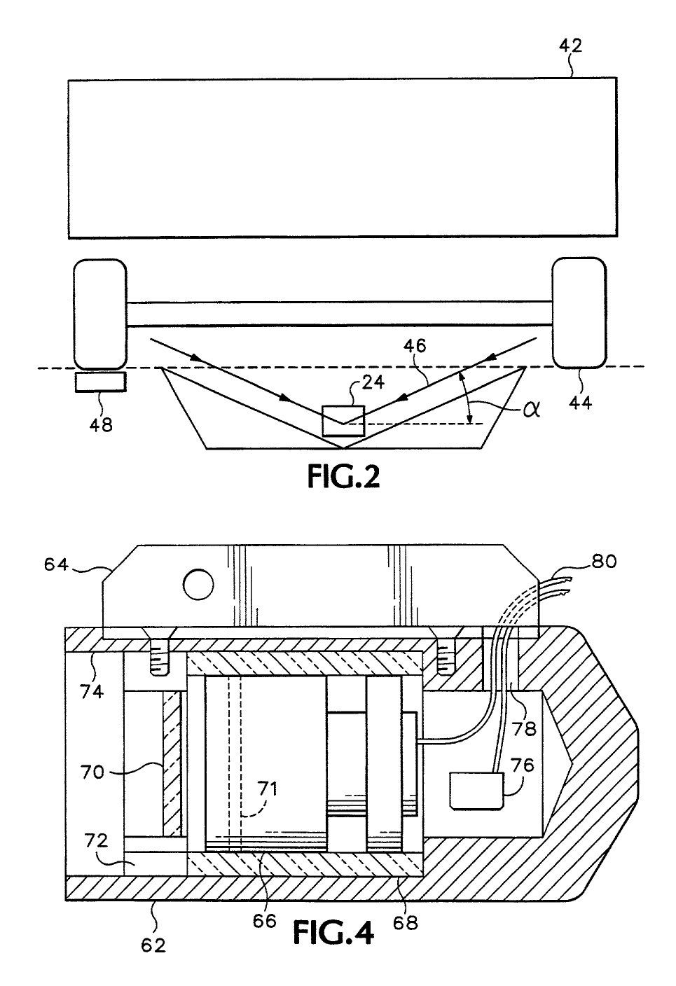

In the preferred embodiment, referring to FIG. 2, a schematic diagram of an inspection station according to the invention, the IR sensors 24 are mounted, either at ground level, or, as illustrated in FIG. 2, below ground level, whereby a truck 42 may be driven over the sensors. Preferably, two sensors are provided, positioned such that one sensor is oriented towards the inside of a first wheel of the truck, and another sensor is oriented towards the inside of a second wheel on the opposite side of the truck. The sensors are oriented upwardly at an angle α, suitably 22° in the preferred embodiment. Once the truck is positioned at a measurement point, the proper position being indicated, for example, by sensor 48, which detects the position of the truck's wheel 44, then the sensors 24 are read, to give the temperature of the brake region of the truck. Since ambient temperature is also measured, the brake temperature can be compared thereto. If the brake region is close to the ambient temperature, then that brake is most likely not functioning, since operating brakes will heat up as the vehicle is slowed down from driving speed as it approaches the measurement point.

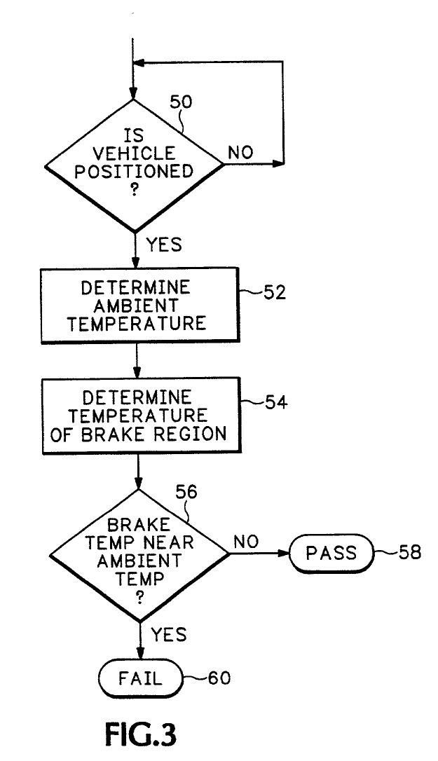

FIG. 3 is a flow chart of the steps of operating the invention. The process begins with decision block 50, wherein it is determined whether the vehicle is positioned for measurement. Once the answer is “yes”, then in block 52, the ambient temperature is determined. The ambient temperature may be determined based on several factors, including both the air temperature around the measurement station, and the temperature of other components of the underneath of the vehicle. For example, the ambient temperature may comprise an average of the underside of the vehicle temperature, determined as the vehicle is driven through the measurement station.

Next, in block 54, the temperature of the brake region of the vehicle is determined, by the IR radiation emitted thereby. If the brake temperature is not near the ambient temperature (i.e., if it is much greater than the ambient temperature) in decision block 56, then a pass indication is made at 58. However, if the brake temperature is near the ambient temperature, then the brakes are likely not functional and a fail indication is provided at 60.

An individual sensor is illustrated in FIG. 4, a partial cross sectional view of a sensor. It may be observed that the sensor comprises an enclosure 62, which has a mounting flange 64 attached thereto to enable mounting at a particular use site. Positioned within the body of enclosure 62 is an infrared optic head assembly 66, which is held in place by thermal/mechanical isolation member 68, which provides a secure engagement between the infrared sensor and the body 62 while also providing thermal and mechanical isolation between the sensor and the body. The body 62 is open at one end thereof and sensor 66 is oriented such that infrared radiation is received to the sensor via the opening in the body. Positioned between the opening and the sensor is a window 70 which assists in preventing contamination of the sensor 66 and also, in the illustrated embodiment, provides a bandpass filtering function to limit the energy reaching the sensor to a desired band. In the illustrated embodiment, the window comprises a zinc selinide or zinc sulfide window, which has a pass band of approximately 5-20 micrometers wavelength. The window 70 is held in position via bezel 72, which is annular in configuration so as to fit within the opening 74 in mounting enclosure 62. It will be understood that while in the illustrated embodiment the enclosure is substantially cylindrical in shape, other shapes may be envisioned with attendant changes in the shape and configuration of the bezel, window and the thermal/mechanical isolation member. Also, enclosed within body 62 is a temperature sensor 76, which detects the ambient temperature of the air and infrared sensor so as to provide temperature compensation, which is used to enable accurate readings from the infrared sensor without interference as a result of the ambient temperature of the sensor itself. A wiring hole 78 is provided in the body 62 to enable sensor wires 80 to pass from the infrared sensor 66 and/or temperature sensor 76 to processing circuitry 12 (FIG. 1).

The infrared sensor 66 also suitably includes a focusing member 71 therewithin, illustrated in phantom in FIG. 4. The focusing member suitably comprises a refractive lens, for example, a plano-convex lens, which allows focusing of the infrared radiation so as to provide sensing of radiation from a surface at a specific distance from the sensor. The focusing element may alternatively be a reflective type focusing system with attendant changes in the orientation of the sensor 66 wherein a convex mirror reflects the energy back to the sensor portion. The focusing element for some applications may be deleted allowing for an unaltered energy field input to the sensor. A field stop, which restricts the field of view or an apertured sensor, may also be employed for controlling the field of view of the sensor element.

A more basic implementation of the invention employs the sensor and a display, whether digital or analog. As a vehicle, such as a truck at an inspection station, drives by the sensor, an inspector observes the display. Normal functioning brakes will cause the display to indicate pronounced temperature spikes as the brake region of each wheel passes the sensor. If no such spike is observed, then the inspector is alerted to take a closer look at the particular brake assembly that did not generate the increased temperature reading.

Therefore, in accordance with the invention, a brake inspection station is provided that determines whether a brake component region of a vehicle is substantially near ambient temperature, which indicates brakes that are not functioning. The inspection station can be permanently mounted at a vehicle inspection site, or can be portable, for placement in the field at impromptu or temporary inspection sites. An easy to use pre-screening device is thereby provided that enables quick determination of whether a vehicle's brakes are functioning, or whether additional inspection of an individual wheel's brakes is warranted.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A method of determining likelihood of brakes of a vehicle being non-functional comprising the steps of:
determining ambient temperature;
determining the temperature of a brake region of the vehicle; and
deciding based on the two determined temperatures whether the brakes are functional.

2. The method of determining likelihood of brakes of a vehicle being non-functional according to claim 1, wherein said step of determining the temperature of a brake region comprises measuring IR emitted by the brake region.

3. The method of determining likelihood of brakes of a vehicle being non-functional according to claim 1, wherein said step of determining the ambient temperature comprises measuring IR emitted by a portion of the vehicle other than in the brake region.

4. The method of determining likelihood of brakes of a vehicle being non-functional according to claim 1, wherein said step of determining the ambient temperature comprises taking plural measurements of IR emitted by plural portions of the vehicle other than in the brake region and determining a temperature value based on said plural measurements.

5. The method of determining likelihood of brakes of a vehicle being non-functional according to claim 4, wherein said step of determining a temperature value based on said plural measurements comprises determining an average of said plural measurements and using said average as the determined temperature value of the vehicle other than in the brake region.

6. The method of determining likelihood of brakes of a vehicle being non-functional according to claim 1, wherein said step of determining the temperature of a brake region of the vehicle comprises providing an IR sensor oriented towards an inner side of a wheel of the vehicle.

7. The method of determining likelihood of brakes of a vehicle being non-functional according to claim 6, wherein said IR sensor is oriented upwardly at approximately 22 degrees relative to a general surrounding region.

8. A method of inspecting brakes of a vehicle comprising the steps of:
providing an IR sensor aimed at an angle to observe a wheel region of a vehicle as a vehicle passes by said IR sensor;
passing a vehicle by said IR sensor;
displaying a representation of temperature of the wheel region of the vehicle as measured by said IR sensor; and
determining functionality of brakes if the wheel region is substantially hotter than ambient temperature.

9. The method according to claim 8, wherein said angle is approximately 22 degrees relative to a lane of travel over which said vehicle is passing by said IR sensor.

10. The method according to claim 8, wherein said displaying step comprises providing a digital representation of temperature.

11. The method according to claim 8, wherein said displaying step comprises providing an analog display to show a representation of relative temperature.

12. An apparatus for determining whether a brake of a vehicle is operational, comprising:
an IR sensor aimed to receive IR radiated from a brake region of a vehicle; and
a processor for receiving output of said IR sensor, said processor including software to determine the temperature of the brake region based on input from the IR sensor, the software deciding that a brake is not operational if the determined temperature of the brake is near an ambient temperature.

13. The apparatus for determining whether a brake of a vehicle is operational according to claim 12, further comprising a display for displaying a representation of the determined temperature.

14. The apparatus for determining whether a brake of a vehicle is operational according to claim 13, wherein said display comprises a digital temperature display.

15. The apparatus for determining whether a brake of a vehicle is operational according to claim 13 wherein said display comprises an analog display.

16. The apparatus for determining whether a brake of a vehicle is operational according to claim 12, further comprising a vehicle sensor for determining when a vehicle is at a measurement position.

17. The apparatus for determining whether a brake of a vehicle is operational according to claim 12, wherein said IR sensor is positioned within a measurement station adapted to be driven over by a vehicle under test.

18. The apparatus for determining whether a brake of a vehicle is operational according to claim 17, wherein said measurement station is substantially below a ground level.

19. The apparatus for determining whether a brake of a vehicle is operational according to claim 12, wherein said IR sensor is aimed upwardly at an angle of approximately 22 degrees relative to a lane of travel through which a vehicle under test is passing.
